(19) United States
(12) Patent Application Publication
(10) Pub. No.: US 2026/0101329 A1
(43) Pub. Date: Apr. 9, 2026

(54) AMBIENT INTERNET OF THINGS DEVICE-TO-READER TRANSMISSION CONTROL

(71) Applicant: QUALCOMM Incorporated, San Diego, CA (US)

(72) Inventors: Le LIU, San Jose, CA (US); Piyush GUPTA, Bridgewater, NJ (US); Raviteja PATCHAVA, San Diego, CA (US); Yuchul KIM, San Diego, CA (US); Kazuki TAKEDA, Minato-ku (JP); Alberto RICO ALVARINO, San Diego, CA (US)

(21) Appl. No.: 19/299,646

(22) Filed: Aug. 14, 2025

Related U.S. Application Data
(60) Provisional application No. 63/705,165, filed on Oct. 9, 2024.

(51) Int. Cl. H04W 72/1263; G16Y 40/10; H04W 72/50

(52) U.S. Cl. CPC H04W 72/1263; G16Y 40/10; H04W 72/50

(57) ABSTRACT

Various aspects of the present disclosure generally relate to wireless communication. In some aspects, a reader may transmit a first wireless communication signal to a first group of ambient internet of things (IoT) devices. The first group of ambient IoT devices may transmit a response to the signal based at least in part on being located within a first range of distances from the reader and the first signal being transmitted at a first transmit power. The reader may transmit a second wireless communication signal to a second group of ambient IoT devices. The second group of ambient IoT devices may transmit a response to the signal based at least in part on being located within a second range of distances from the reader and the signal being transmitted at a second transmit power. Numerous other aspects are described.

### CROSS-REFERENCE TO RELATED APPLICATION

This patent application claims priority to U.S. Provisional Patent Application No. 63/705,165, filed on Oct. 9, 2024, entitled “AMBIENT INTERNET OF THINGS DEVICE-TO-READER TRANSMISSION CONTROL,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with ambient Internet-of-Things device-to-reader transmission control.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a reader. The method may include transmitting, by the reader, a first wireless communication signal to a first group of ambient internet of things (IOT) devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power. The method may include transmitting, by the reader, a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

Some aspects described herein relate to a method of wireless communication performed by an ambient IoT device. The method may include receiving, by the ambient IoT device, a first wireless communication signal. The method may include transmitting, by the ambient IoT device, a response to the first wireless communication signal. The method may include receiving, by the ambient IoT device, a second wireless communication signal, wherein the ambient IoT refrains from transmitting a response to the second wireless communication signal based at least in part on transmitting the response to the first wireless communication signal.

Some aspects described herein relate to a non-transitory computer-readable medium that stores a set of instructions for wireless communication by a reader. The set of instructions, when executed by one or more processors of the reader, may cause the reader to transmit a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power. The set of instructions, when executed by one or more processors of the reader, may cause the reader to transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

Some aspects described herein relate to a non-transitory computer-readable medium that stores a set of instructions for wireless communication by an ambient IoT device. The set of instructions, when executed by one or more processors of the ambient IoT device, may cause the ambient IoT device to receive a first wireless communication signal. The set of instructions, when executed by one or more processors of the ambient IoT device, may cause the ambient IoT device to transmit a response to the first wireless communication signal. The set of instructions, when executed by one or more processors of the ambient IoT device, may cause the ambient IoT device to receive a second wireless communication signal, wherein the ambient IoT refrains from transmitting a response to the second wireless communication signal based at least in part on transmitting the response to the first wireless communication signal.

Some aspects described herein relate to a reader for wireless communication. The reader may include one or more memories. The one or more processors, individually or collectively based at least in part on information stored in the one or more memories, may be configured to transmit a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power. The one or more processors, individually or collectively based at least in part on information stored in the one or more memories, may be configured to transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

Some aspects described herein relate to an ambient IoT device for wireless communication. The ambient IoT device may include one or more memories. The one or more processors, individually or collectively based at least in part on information stored in the one or more memories, may be configured to receive a first wireless communication signal. The one or more processors, individually or collectively based at least in part on information stored in the one or more memories, may be configured to transmit a response to the first wireless communication signal. The one or more processors may be configured to receive a second wireless communication signal, wherein the ambient IoT refrains from transmitting a response to the second wireless communication signal based at least in part on transmitting the response to the first wireless communication signal.

Some aspects described herein relate to an apparatus for wireless communication. The apparatus may include means for transmitting a first wireless communication signal to a first group of ambient IoT devices, wherein the first group of ambient IoT devices transmit a response to the first wireless communication signal based at least in part on the first group of ambient IoT devices being located within a first range of distances from the apparatus and based at least in part on the first wireless communication signal being transmitted at a first transmit power. The apparatus may include means for transmitting a second wireless communication signal to a second group of ambient IoT devices, wherein the second group of ambient IoT devices transmit a response to the second wireless communication signal based at least in part on the second group of ambient IoT devices being located within a second range of distances from the apparatus and based at least in part on the second wireless communication signal being transmitted at a second transmit power that is different from the first transmit power.

Some aspects described herein relate to an apparatus for wireless communication. The apparatus may include means for receiving a first wireless communication signal. The apparatus may include means for transmitting a response to the first wireless communication signal. The apparatus may include means for receiving a second wireless communication signal, wherein the apparatus refrains from transmitting a response to the second wireless communication signal based at least in part on transmitting the response to the first wireless communication signal.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples associated with different types of ambient internet of things (IoT) devices, in accordance with the present disclosure.

FIG. 4 is a diagram illustrating an example associated with backscatter communications, in accordance with the present disclosure.

FIG. 5 is a diagram illustrating examples of topologies for ambient IoT devices, in accordance with the present disclosure.

FIGS. 6A and 6B are diagrams illustrating an example of monostatic and bistatic implementations for ambient IoT devices, in accordance with the present disclosure.

FIGS. 7A and 7B are diagram illustrating an example associated with ambient IoT device device-to-reader transmission control, in accordance with the present disclosure.

FIG. 8 is a diagram illustrating an example process performed, for example, at a reader or an apparatus of a reader, in accordance with the present disclosure.

FIG. 9 is a diagram illustrating an example process performed, for example, at an ambient IoT device or an apparatus of an ambient IoT device, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communication devices may be considered Internet of Things (IoT) devices, such as ambient IoT devices (sometimes referred to as ultra-light IoT devices), or similar IoT devices. Ambient IoT technology may include passive IoT (e.g., NR passive IoT for 5G Advanced), semi-passive IoT, or ultra-light IoT, among other examples. In passive IoT, a terminal (e.g., a radio frequency identification (RFID) device, a tag, or a similar device) may not include a battery, and the terminal may accumulate energy from radio signaling. Additionally, the terminal may accumulate solar or other energy to supplement accumulated energy from radio signaling. Passive IoT devices may have a relatively small communication range and may have a minimal power consumption to support operation without a battery.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, a wireless communication network may utilize a type of passive IoT device referred to as an “ambient backscatter device” or a “backscatter device.” A backscatter device may communicate with a reader (e.g., a user equipment (UE) or a network node) by modulating a reflecting radio signal from an RF source. In some examples, the RF source and the reader may be the same device and/or may be co-located. For example, in some cases, the reader and the RF source may be associated with the same network node.

To facilitate communication of the backscatter device, the RF source may transmit an energy harvesting wave to the backscatter device. Once energy is sufficiently accumulated at the backscatter device, the backscatter device may begin to reflect the radio wave that is radiated onto the backscatter device. The backscatter device may have reflection-on periods and reflection-off periods that follow a pattern that is based at least in part on the transmission of information bits by the backscatter device. The backscatter device may use an information modulation scheme, such as amplitude shift keying (ASK) modulation or on-off keying (OOK) modulation. For ASK or OOK modulation, the backscatter device may switch on reflection when transmitting an information bit “1” and switch off reflection when transmitting an information bit “0.” The reader may detect the reflection pattern of the backscatter device and obtain the backscatter communication information.

Some IoT devices may be referred to as semi-passive IoT devices. At a semi-passive IoT device, communication between a reader and the IoT device does not need to be preceded by an energy harvesting waveform. For example, semi-passive IoT devices may include a battery or similar energy source that can power the receiver and/or logic circuit. For such devices, energy harvesting may still be triggered in some cases, such as for long-range communications. In that regard, passive and semi-passive IoT devices may be inherently limited for certain applications. In addition to passive devices and semi-passive devices, some IoT devices may be active IoT devices. An active IoT device may have a battery or similar energy source and an active radio, allowing for active transmission and reception without energy harvesting or backscattering.

An ambient IoT communication link may include a forward link and a backward link. “Forward link” (or “FL”) refers to a communication direction from a reader to a tag device (e.g., an RFID device or a terminal device), and “backward link” (or “BL”) refers to a communication direction from a tag device to a reader. The FL may be referred to as a downlink and the BL may be referred to as an uplink.

In certain situations, such as inventory management, ambient IoT devices can be energized by a backscatter signal (e.g., a continuous wave) transmitted from a reader. When an ambient IoT device is sufficiently energized, the ambient IoT device can transmit data to the reader. In some cases, an ambient IoT device must be close to the reader (e.g., within a few meters) in order for the reader to communicate with the ambient IoT device. The range of the ambient IoT device can be extended by having the reader transmit the continuous wave at a higher transmit (Tx) power.

In some cases, a received power of the signals at the reader may vary based at least in part on a location of the ambient IoT devices from the reader. For example, a reader may receive a signal from a first ambient IoT device at a higher power than a signal received from a second ambient IoT device that is further away from the reader that the first ambient IoT device. In some cases, the disparity in power between the two signals may be great enough to prevent the reader from detecting the signal transmitted by the second ambient IoT device. In these cases, the signal transmitted the first ambient IoT device may essentially overpower, block out, or otherwise prevent the reader from detecting and/or receiving the signal transmitted by the second ambient IoT device (referred to herein as a “near-far problem”).

Various aspects relate generally to utilizing different transmit powers to wireless communication signals to different groups of ambient IoT devices. Some aspects more specifically relate to transmitting a first wireless communication signal to a first group of ambient IoT devices at a first transmit power and transmitting a second wireless communication signal to a second group of ambient IoT devices at a second transmit power. In some aspects, the first group of ambient IoT devices may transmit a response to the first wireless communication signal based at least in part on the first wireless communication signal being transmitted at the first transmit power. In some aspects, the first group of ambient IoT devices may not transmit a response to the second wireless communication signal based at least in part on having transmitted a response to the first wireless communication signal and/or based at least in part on the second wireless communication signal being transmitted at the second transmit power.

Particular aspects of the subject matter described in this disclosure can be implemented to realize one or more of the following potential advantages. In some examples, the described techniques can be used to mitigate an effect of a near-far problem when transmitting a query to multiple ambient IoT devices that are positioned at varying distances from a reader.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

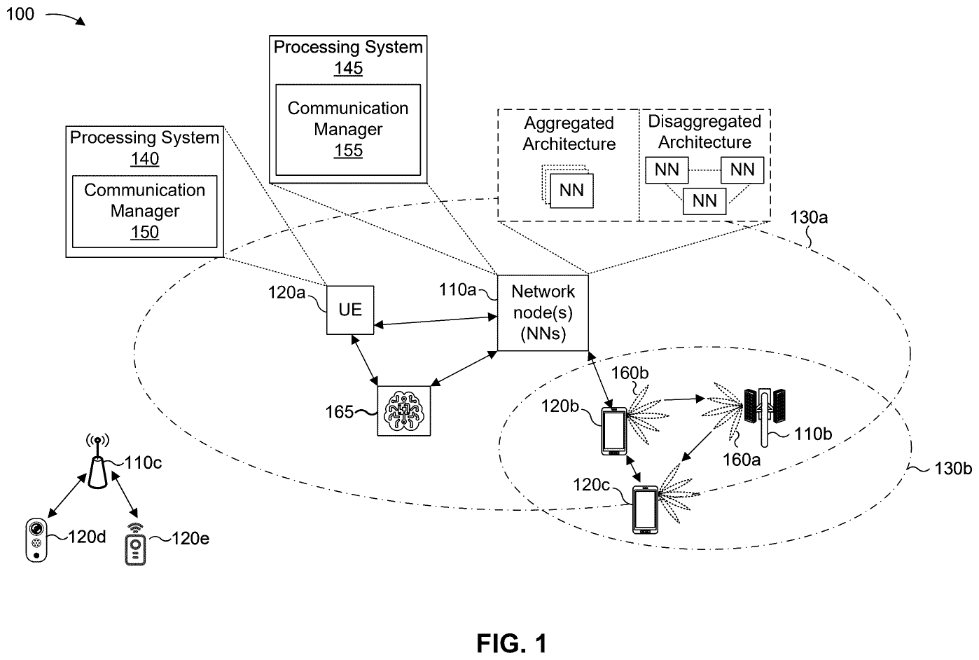

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

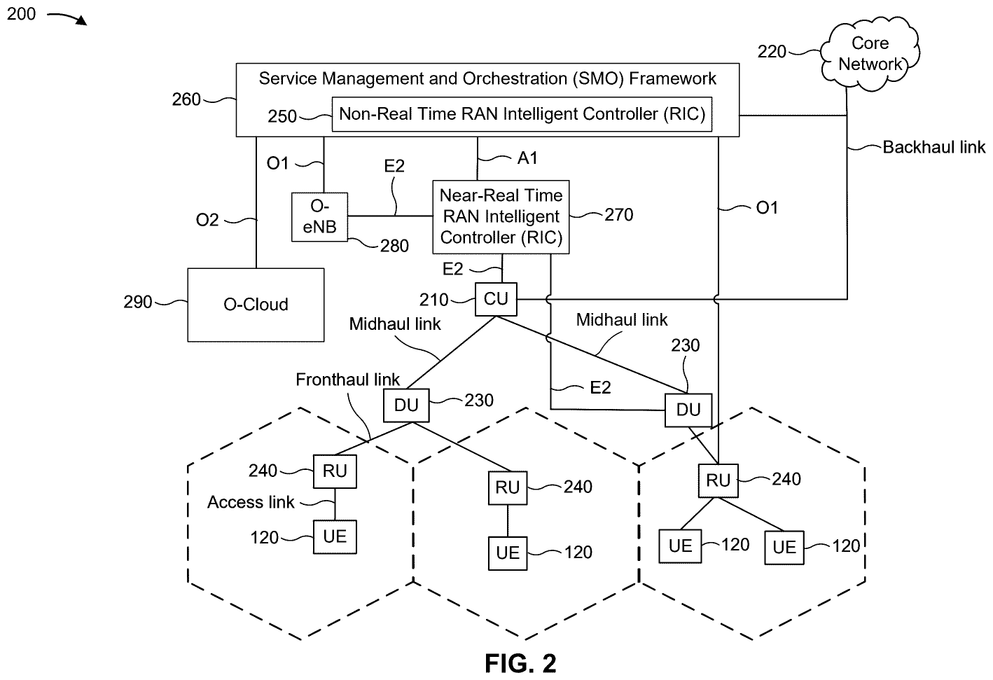

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Some IoT devices, such as ambient IoT devices, may be associated with a relatively simple hardware design that may be designed to use low power and be implementable at low cost. An ambient IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. Ambient IoT technology may be useful in connection with industrial sensors, for which battery replacement may be prohibitively difficult or undesirable (such as for safety monitoring or fault detection in smart factories, infrastructures, or environments). Additionally, features of ambient IoT devices, such as low cost, small size, simple or infrequent maintenance, durability, and long lifespan, may facilitate smart logistics and warehousing (for example, in connection with automated asset management). Furthermore, ambient IoT technology may be useful in connection with smart home networks for household item management, wearable devices, or similar applications.

In some aspects, a reader may comprise a UE 120 and/or a network node 110 and may include a communication manager 150 and/or a communication manager 155. As described in more detail elsewhere herein, the communication manager 150 and/or the communication manager 155 may transmit a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power. Additionally, or alternatively, the communication manager 150 and/or the communication manager 155 may perform one or more other operations described herein.

In some aspects, a ambient IoT device may comprise a UE 120 and may include a communication manager 150. As described in more detail elsewhere herein, the communication manager 150 may receive a first wireless communication signal; transmit a response to the first wireless communication signal; and receive a second wireless communication signal, wherein the ambient IoT refrains from transmitting a response to the second wireless communication signal based at least in part on transmitting the response to the first wireless communication signal. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

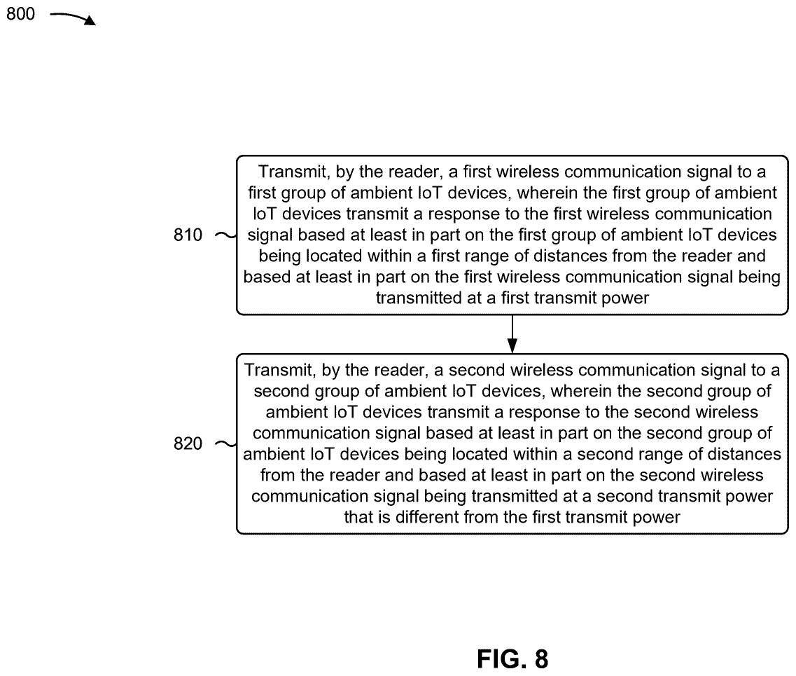

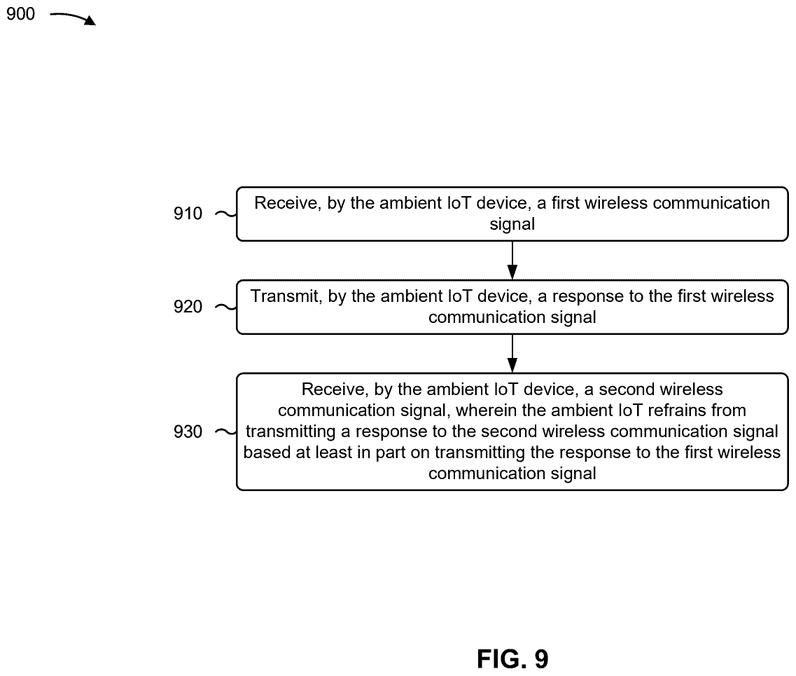

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with ambient IoT device device-to-reader transmission control, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). In some aspects, the reader described herein is the network node 110, is included in the network node 110, or includes one or more components of the network node 110 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

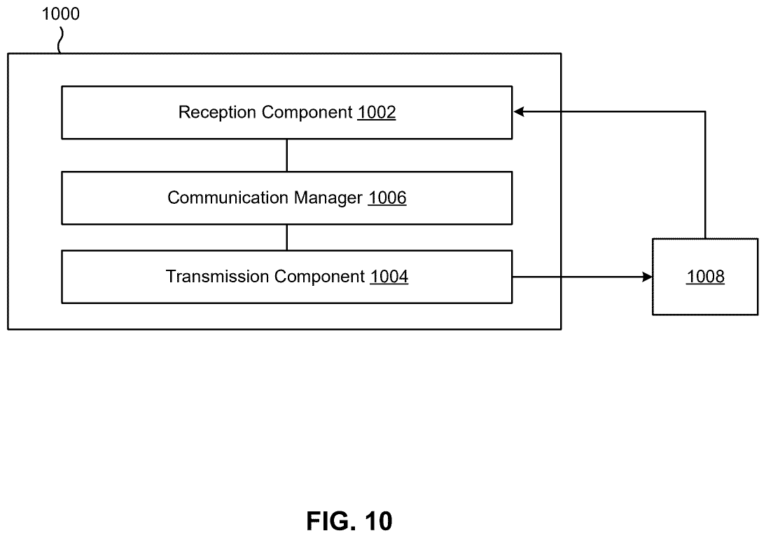

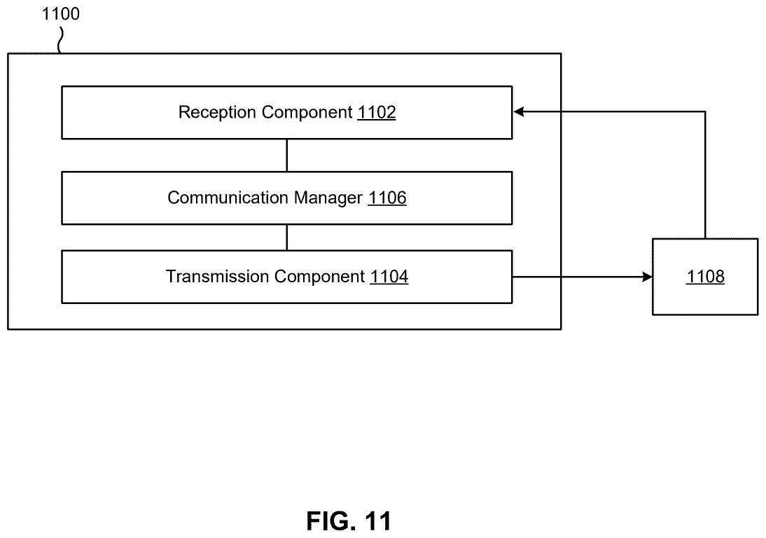

In some aspects, a reader (e.g., a UE 120 and/or a network node 110) includes means for transmitting, by the reader, a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and/or means for transmitting, by the reader, a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power. In some aspects, the means for the reader to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples. In some aspects, the means for the reader to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

In some aspects, an ambient IoT device (e.g., a UE 120) includes means for receiving, by the ambient IoT device, a first wireless communication signal; means for transmitting, by the ambient IoT device, a response to the first wireless communication signal; and/or means for receiving, by the ambient IoT device, a second wireless communication signal, wherein the ambient IoT refrains from transmitting a response to the second wireless communication signal based at least in part on transmitting the response to the first wireless communication signal. In some aspects, the means for the ambient IoT device to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

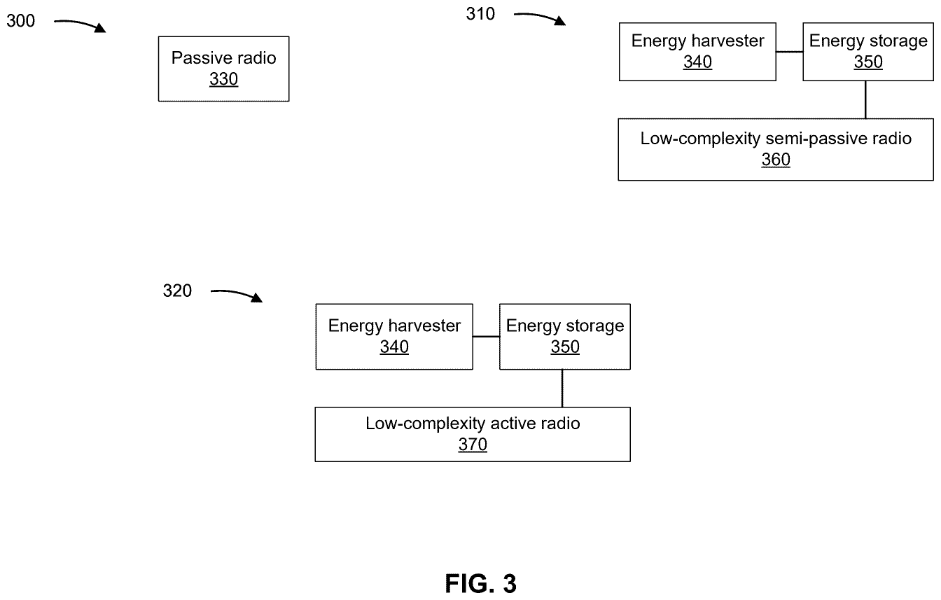

FIG. 3 is a diagram illustrating examples 300, 310, and 320 associated with different types of ambient IoT devices, in accordance with the present disclosure.

Example 300 illustrates components of a passive ambient IoT device. As shown, passive ambient IoT devices may include a passive radio 330. For example, the passive radio 330 may be configured to backscatter a carrier wave (CW).

Example 310 illustrates components of a semi-passive ambient IoT device. As shown, semi-passive ambient IoT devices may include an energy harvester 340, an energy storage 350, and/or a low-complexity semi-passive radio 360. For example, the low-complexity semi-passive radio 360 may be configured to harvest energy from a CW using the energy harvester 340, store energy from a CW using the energy storage 350, and/or backscatter a CW.

Example 320 illustrates components of an active ambient IoT device. As shown, active ambient IoT devices may include an energy harvester 340, an energy storage 350, and/or a low-complexity (for example, low-cost) active radio 370. For example, the low-complexity active radio 370 may be configured to harvest energy from a CW using the energy harvester 340, store energy from a CW using the energy storage 350, and/or backscatter a CW.

Ambient IoT devices may be categorized into at least three types of devices: device 1, device 2a, and device 2b. Device 1 type ambient IoT devices may include at least some passive and/or semi-passive devices. A device 1 type ambient IoT device may have approximately 1 μW peak power consumption, support energy storage, use an initial sampling frequency offset (SFO) up to 10× ppm (for example, where X can be any suitable value), and communicate uplink transmissions by backscattering externally-provided CWs.

Device 2a type ambient IoT devices may include at least some semi-passive devices, and device 2b type ambient IoT devices may include active devices. Both device 2a and device 2b type ambient IoT devices may have less than or equal to a few hundred μW peak power consumption, support energy storage, and use an initial SFO up to 10× ppm. A device 2a type ambient IoT device may communicate uplink transmissions by backscattering externally-provided CWs. A device 2b type ambient IoT device may communicate uplink transmissions by internally generating the uplink transmission.

In some examples, device 1, device 2a, and/or device 2b type ambient IoT devices that are located indoors may support a maximum distance of 10-50 m, a range which may be sub-selected. In Topology 1 (for example, in which an ambient IoT device may directly and bidirectionally communicate with one or more network nodes 110) and in Topology 2 (for example, in which an ambient IoT device may communicate bidirectionally with an intermediate node between the ambient IoT device and a network node 110), device 1, device 2a, and/or device 2b type ambient IoT devices may not support RRC states, mobility (for example, cell-selection/re-selection-like functionality), automatic repeat request (ARQ), or hybrid ARQ (HARQ).

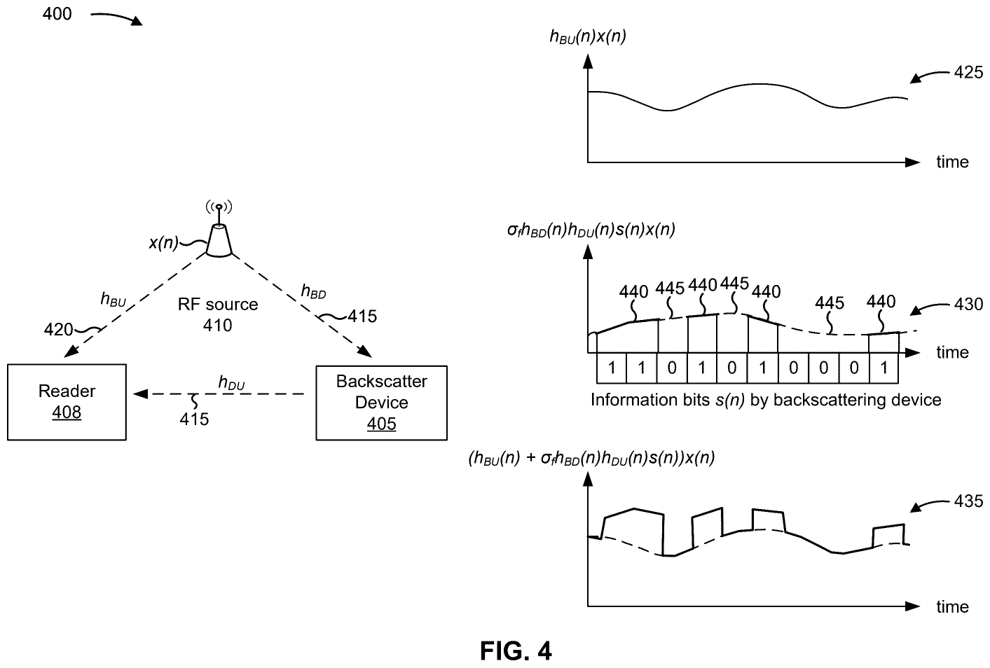

FIG. 4 is a diagram illustrating an example 400 associated with backscatter communications, in accordance with the present disclosure.

Some wireless communication devices may be considered IoT devices, such as ambient IoT devices, or similar IoT devices. In ambient IoT, a terminal (for example, an RFID device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 4, a backscatter device 405 (for example, a tag or a sensor, among other examples), which may be one example of an ambient IoT device such as a passive, semi-passive, or active ambient IoT device described with regard to FIG. 3, may employ a simplified hardware design (for example, including a power splitter, an energy harvester, and a microcontroller) that does not include a battery, such that the backscatter device 405 relies on energy harvesting for power, and that does not include a radio wave generation circuit, such that the backscatter device 405 is capable of transmitting information only by reflecting a radio wave. More particularly, the backscatter device 405 communicates with a reader 408 (for example, a UE 120, a network node 110, or another network device) by modulating a reflecting radio signal from an RF source 410 (for example, a network node 110, a UE 120, or another network device). In some examples, the RF source 410 and the reader 408 may be the same device and/or may be co-located. For example, in some instances, the reader 408 and the RF source 410 may be associated with the same network node 110.

To facilitate communication of the backscatter device 405, the RF source 410 may transmit an energy harvesting wave to the backscatter device 405. The energy harvesting wave may be transmitted for a sufficient duration in order to enable a communication phase for a target range between the reader 408 and the backscatter device 405. Additionally or alternatively, in some instances, a range between the RF source 410 and the backscatter device 405 may be limited by a minimum received power for triggering energy harvesting at the backscatter device 405, such as −20 decibel milliwatts (dBm).

Once energy is sufficiently accumulated at the backscatter device 405, the backscatter device 405 may begin to reflect the radio wave that is radiated onto the backscatter device 405 via a backscatter link 415. For example, the RF source 410 may initiate a communication session (sometimes referred to as a query-response communication) with a query, which may be a modulating envelope of a CW. The backscatter device 405 may respond by backscattering of the CW. The communication session may include multiple rounds, such as for purposes of contention resolution when multiple backscatter devices respond to a query. A channel between the RF source 410 and the backscatter device 405 of the backscatter link 415 may be associated with a first backscatter link channel response value (sometimes referred to as a first backscatter link channel coefficient or a first backscatter link gain value), hBD. As described below, the backscatter device 405 may have reflection-on periods and reflection-off periods that follow a pattern that is based at least in part on the transmission of information bits by the backscatter device 405. The reader 408 may detect the reflection pattern of the backscatter device 405 and obtain the backscatter communication information via the backscatter link 415. A channel between the reader 408 and the backscatter device 405 of the backscatter link 415 may be associated with a second backscatter link channel response value (sometimes referred to as a second backscatter link channel coefficient or a second backscatter link channel gain value), hDU. In addition, the RF source 410 and the reader 408 may communicate (for example, reference signals and/or data signals) via a direct link 420. A channel between the RF source 410 and the reader 408 of the direct link 420 may be associated with a direct link channel response value (sometimes referred to as a direct link channel coefficient or a direct link channel gain value), hBU. This signal is shown by reference number 425.

Thus, the resulting signal received at the reader 408, which is the superposition of the signal received via the direct link 420 and the signal received via the backscatter link 415, may be denoted as y(n). This signal, y(n), is shown by reference number 435. As shown, when s(n)=0 (indicated by reference number 440 in the plot shown at reference number 430), the backscatter device 405 may switch off reflection, and thus the reader 408 receives only the direct link 420 signal. When s(n)=1 (indicated by reference number 445 in the plot shown at reference number 430), the backscatter device 405 may switch on reflection, and thus the reader 408 receives a superposition of both the direct link 420 signal and the backscatter link 415 signal. To receive the information bits transmitted by the backscatter device 405, the reader 408 may first decode x(n) based at least in part on the direct link channel response value of hBU(n) by treating the backscatter link 415 signal as interference. The reader 408 may then detect the existence of the signal component.

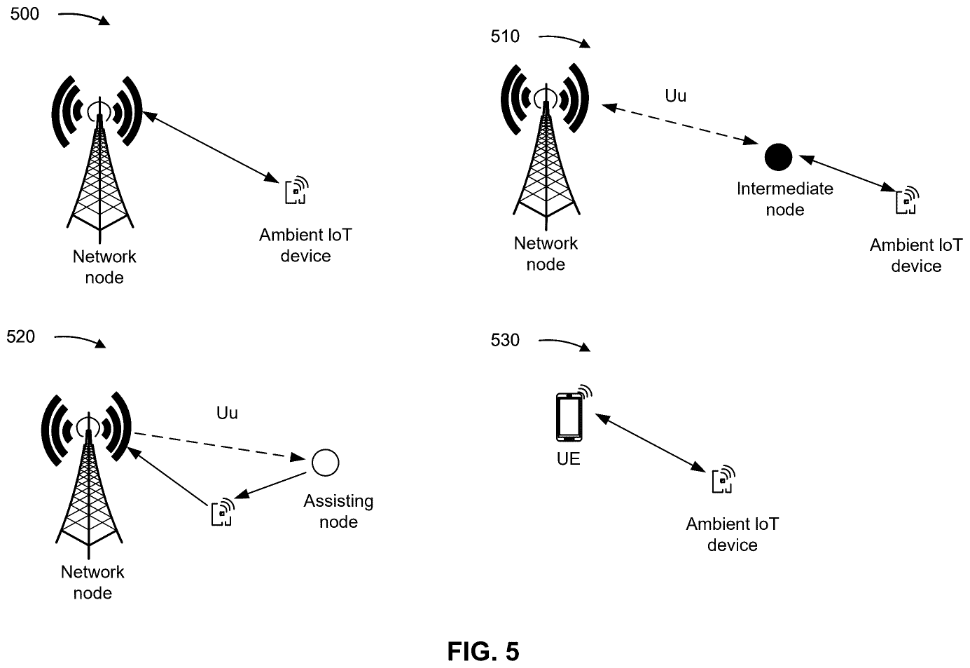

FIG. 5 is a diagram illustrating examples 500-540 of topologies for ambient IoT devices, in accordance with the present disclosure.

Example 500 relates to a first topology, which may be referred to as topology 1. In topology 1, an ambient IoT device may directly and bidirectionally communicate with one or more network nodes. For example, the ambient IoT device and the one or more network nodes may communicate ambient IoT data and/or signaling. In some examples, a first network node may transmit communications to the ambient IoT device and a second network node may receive communications from the ambient IoT device.

Example 510 relates to a second topology, which may be referred to as topology 2. In topology 2, the ambient IoT device may communicate bidirectionally with an intermediate node between the ambient IoT device and a network node. The intermediate node may be any suitable device that is capable of ambient IoT, such as a relay, an IAB node, a UE, or a repeater, among other examples. The intermediate node may transfer ambient IoT data and/or signaling between network node and the ambient IoT device.

Example 520 relates to a third topology, which may be referred to as topology 3. In some examples, in topology 3, the ambient IoT device may transmit ambient IoT data and/or signaling to a network node and may receive ambient IoT data and/or signaling from an assisting node. In some examples, in topology 3, the ambient IoT device may receive ambient IoT data and/or signaling from the network node and may transmit ambient IoT data and/or signaling to the assisting node. The assisting node may be any suitable device that is capable of ambient IoT, such as a relay, an IAB node, a UE, or a repeater, among other examples.

Example 530 relates to a fourth topology, which may be referred to as topology 4. In topology 4, an ambient IoT device may bidirectionally communicate with a UE. For example, the ambient IoT device and the UE may communicate ambient IoT data and/or signaling.

As indicated above, FIG. 5 is provided as an example. Other examples may differ from what is described with respect to FIG. 5.

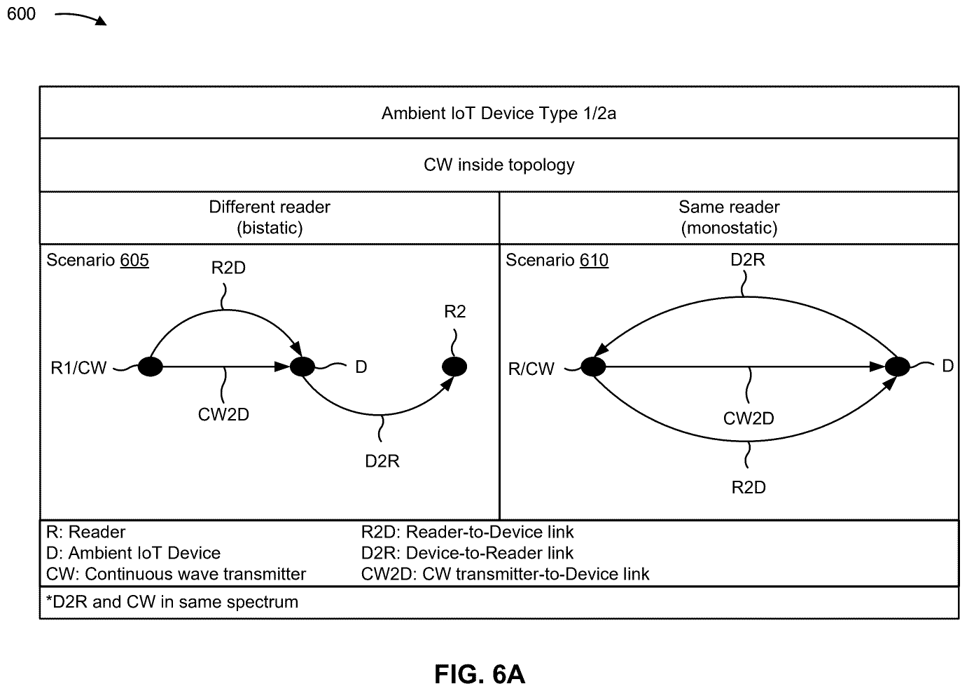

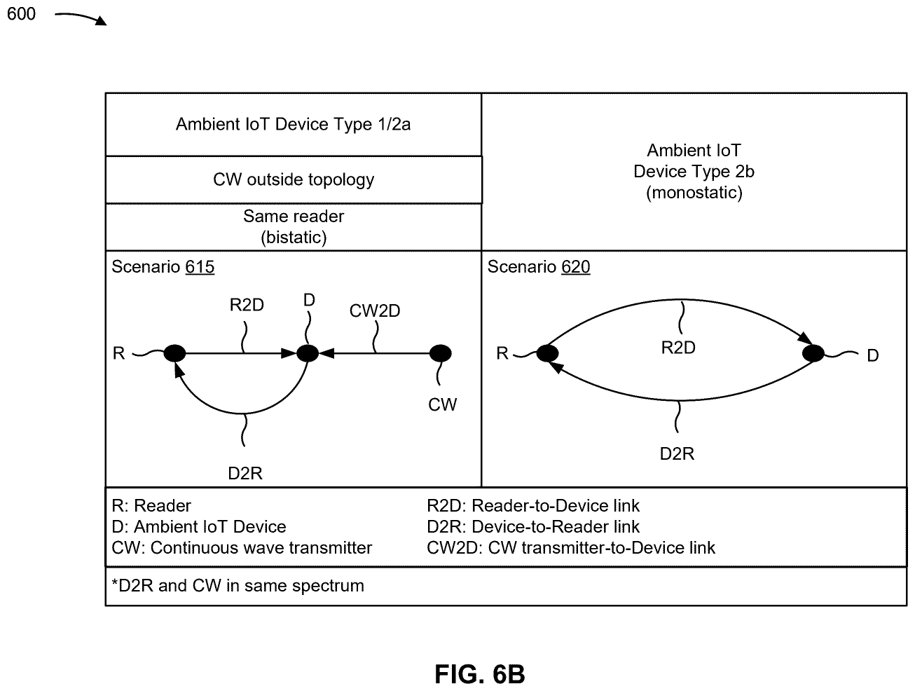

FIGS. 6A and 6B are diagrams illustrating an example 600 of monostatic and bistatic implementations for ambient IoT devices, in accordance with the present disclosure. As shown in FIGS. 6A and 6B, example 600 may include scenarios 605, 610, 615, and 620. As shown in FIG. 6A, in some cases, an ambient IoT device may comprise a device 1 type ambient IoT device or a device 2a type ambient IoT device associated with a CW inside topology. In some cases, the CW inside topology may include a reader that is configured to transmit a wireless communication signal and a CW signal.

In some cases, the CW inside topology may comprise a bistatic implementation. In some cases, the bistatic implementation may comprise an implementation in which an ambient IoT device receives a wireless communication signal and a CW signal from a first reader and transmits a response to a second, different reader.

For example, as shown in scenario 605, a first reader (e.g., reader R1/CW, as shown in FIG. 6A) may transmit a wireless communication signal to an ambient IoT device via a reader-to-device link (e.g., an R2D link, as shown in FIG. 6A) and may transmit a CW signal to the ambient IoT device via a CW-to-device link (e.g., a CW2D link, as shown in FIG. 6A). The ambient IoT device may utilize the CW signal to transmit a response to a second reader (e.g., R2, as shown in FIG. 6A) via a device-to-reader link (e.g., a D2R link, as shown in FIG. 6A).

In some cases, the CW inside topology may comprise a monostatic implementation. In some cases, the monostatic implementation may comprise an implementation in which an ambient IoT device receives a wireless communication signal and a CW signal from a reader and transmits a response to the reader from which the wireless communication signal and the CW signal was transmitted.

For example, as shown in scenario 610, a reader (e.g., reader R/CW, as shown in FIG. 6A) may transmit a wireless communication signal to an ambient IoT device via a reader-to-device link (e.g., an R2D link, as shown in FIG. 6A) and may transmit a CW signal to the ambient IoT device via a CW-to-device link (e.g., a CW2D link, as shown in FIG. 6A). The ambient IoT device may utilize the CW signal to transmit a response to the reader via a device-to-reader link (e.g., a D2R link, as shown in FIG. 6A).

As shown in FIG. 6B, in some cases, an ambient IoT device may comprise a device 1 type ambient IoT device or a device 2a type ambient IoT device associated with a CW outside topology. In some cases, the CW outside topology may include a reader that is configured to transmit a wireless communication signal and a CW transmitter that is configured to transmit a CW signal.

In some cases, the CW outside topology may comprise a bistatic implementation. In these cases, the bistatic implementation may comprise an implementation in which an ambient IoT device receives a wireless communication signal from a reader, receives a CW signal from a CW transmitter, and transmits a response to reader.

For example, as shown in scenario 615, a reader (e.g., a reader R, as shown in FIG. 6A) may transmit a wireless communication signal to an ambient IoT device via a reader-to-device link (e.g., an R2D link, as shown in FIG. 6B). A CW transmitter (e.g., a CW transmitter CW, as shown in FIG. 6B) may transmit a CW signal to the ambient IoT device via a CW-to-device link (e.g., a CW2D link, as shown in FIG. 6B). The ambient IoT device may utilize the CW signal to transmit a response to the reader via a device-to-reader link (e.g., a D2R link, as shown in FIG. 6B).

In some cases, the ambient IoT device may comprise a device 2b type ambient IoT device. The device 2b type ambient IoT device may include an active device that supports energy storage and that communicates a response by internally generating the transmission (e.g., rather than communicating the response by backscattering a CW signal). In some cases, as shown in scenario 620, the Type 2b ambient IoT device may be associated with a monostatic implementation.

In some cases, the monostatic implementation may comprise an implementation in which an ambient IoT device receives a wireless communication signal from a reader and transmits a response to the reader from which the wireless communication signal was transmitted. For example, as shown in scenario 620, a reader (e.g., reader R, as shown in FIG. 6B) may transmit a wireless communication signal to an ambient IoT device via a reader-to-device link (e.g., an R2D link, as shown in FIG. 6B). The ambient IoT device may transmit a response to the reader via a device-to-reader link (e.g., a D2R link, as shown in FIG. 6B).

As indicated above, FIGS. 6A and 6B are provided as an example. Other examples may differ from what is described with respect to FIGS. 6A and 6B.

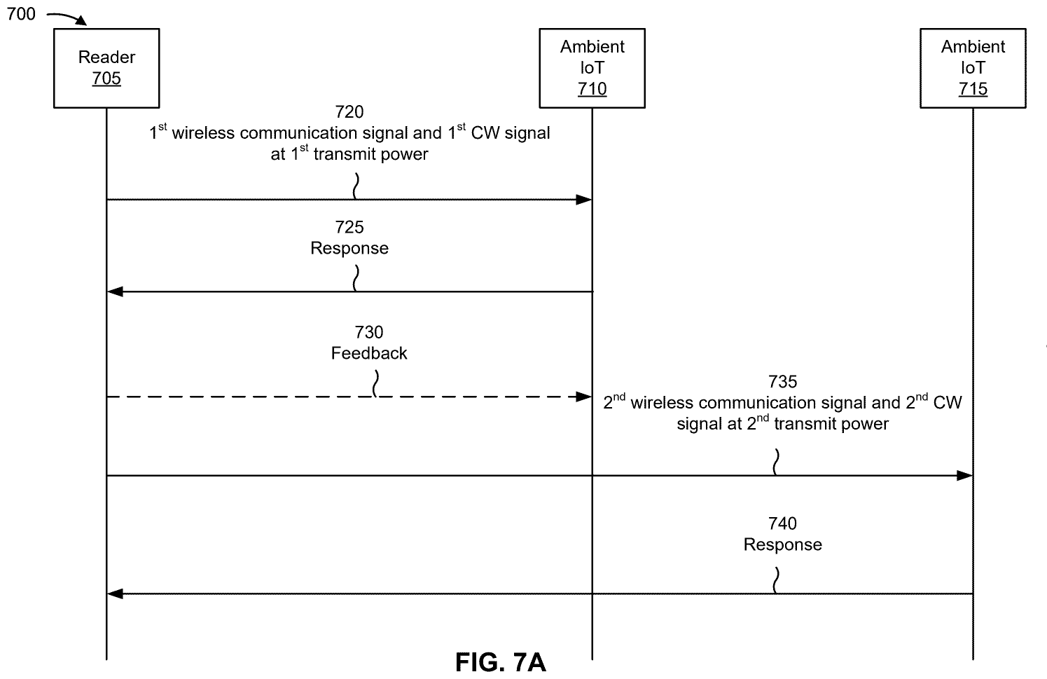

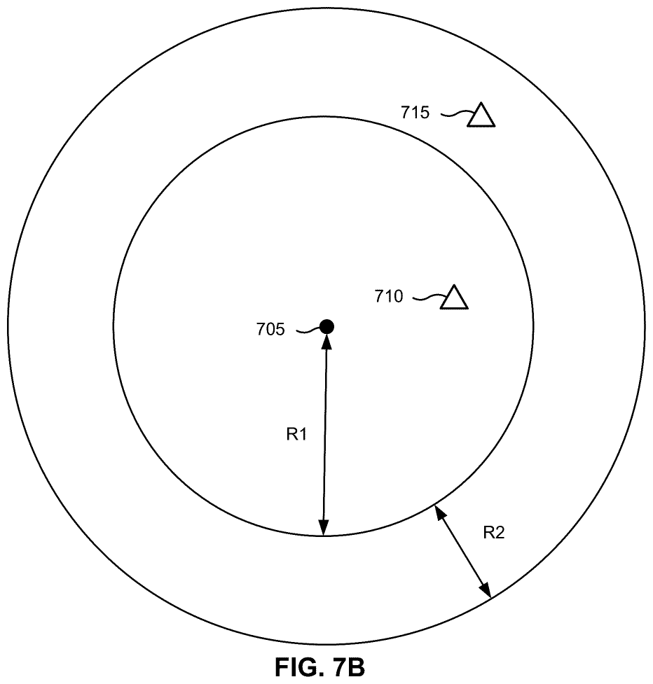

FIGS. 7A and 7B are diagram illustrating an example 700 associated with ambient IoT device device-to-reader transmission control, in accordance with the present disclosure. As shown in example 700, a reader 705, an ambient IoT device 710, and an ambient IoT device 715 may communicate with one another.

In some aspects, the ambient IoT device 710 and the ambient IoT device 715 may both comprise device 1 type ambient IoT devices. In some aspects, the ambient IoT device 710 and the ambient IoT device 715 may both comprise a device 2a type ambient IoT devices. In some aspects, the ambient IoT device 710 and the ambient IoT device 715 may comprise a combination of device 1 type and device 2a type ambient IoT devices. For example, the ambient IoT device 710 may comprise a device 1 type ambient IoT device and the ambient IoT device 715 may comprise a device 2a type ambient IoT device or the ambient IoT device 710 may comprise a device 2a type ambient IoT device and the ambient IoT device 715 may comprise a type 1 device ambient IoT device. Additionally, or alternatively, one or more of the ambient IoT device 710 or the ambient IoT device 715 may comprise a device 2b type ambient IoT device.

In some aspects, the ambient IoT device 710 and the ambient IoT device 715 may be at different distances from the reader 705. For example, as shown in FIG. 7B, a distance between the reader 705 and the ambient IoT device 710 may be within a first range of distances R1 and a distance between the reader 705 and the ambient IoT device 715 may be within a second, different range of distances R2. In some aspects, the first range of distances R1 and the second range of distances R2 may be non-overlapping ranges of distances. For example, a maximum distance included in the first range of distances R1 may be less than, or equal to a minimum distance included in the second range of distances R2.

In some aspects, the first range of distances R1 and the second range of distances R2 may be partially overlapping ranges of distances. For example, the maximum distance included in the first range of distances R1 may be greater than the minimum distance included in the second range of distances R2 and may be less than a maximum distance included in the second range of distances.

As shown in FIG. 7A, and by reference number 720, the reader 705 may transmit a first wireless communication signal and a first CW signal at a first transmit power. In some aspects, the first wireless communication signal may comprise a reader-to-device signal that is transmitted via a reader-to-device communication link between the reader 705 and the ambient IoT device 710.

In some aspects, the first CW signal may be transmitted via a CW communication link between the reader 705 and the ambient IoT device 710. In some aspects, the CW signal may be transmitted by another device that is different than the reader 705, and the CW signal may be transmitted via a CW communication link between the other device and the ambient IoT device 710. In some aspects, the other device may comprise a CW transmitter and/or another reader, as described in greater detail elsewhere herein.

In some aspects, the reader 705 may receive information indicating that the CW signal is to be transmitted by the other device and/or that the reader 705 is to refrain from transmitting the CW signal to the ambient IoT device 710. For example, a network node or an ambient IoT device controller may transmit information to the reader 705 indicating that the CW signal is to be transmitted by the other device and/or that the reader 705 is to refrain from transmitting the CW signal to the ambient IoT device 710.

In some aspects, the ambient IoT device 710 may be included in a first group of ambient IoT devices located within the first range of distances R1, and the first wireless communication signal and the first CW signal may be transmitted at the first transmit power to enable the first group of ambient IoT devices to receive the first wireless communication signal and to utilize the first CW signal to transmit a response to the first wireless communication signal.

In some aspects, the first transmit power may comprise a low transmit power relative to a second transmit power at which a second wireless communication signal and/or a second CW signal are transmitted (described in greater detail below). In some aspects, the reader 705 may transmit the second wireless communication signal and/or the second CW signal based at least in part on performing power ramping to incrementally increase the transmit power from the first transmit power to the second transmit power.

In some aspects, the first transmit power may comprise a high transmit power relative to the second transmit power. In some aspects, the reader 705 may transmit the second wireless communication signal and/or the second CW signal to a second group of ambient IoT devices located within the second range of distances R2. In some aspects, the reader 705 may transmit the first wireless communication signal and/or the first CW signal based at least in part on performing power de-ramping to incrementally decrease the transmit power from the second transmit power to the first transmit power.

In some aspects, the ambient IoT device 715 may not receive the first wireless communication signal and/or the first CW signal. In some aspects, the ambient IoT device 715 may not receive the first wireless communication signal and/or the first CW signal based at least in part on the first wireless communication signal and/or the first CW signal being transmitted at the first transmit power. For example, the ambient IoT device 715 may be included in a second group of ambient IoT devices located within the second range of distances R2, and the first transmit power may decrease a probability of the first wireless communication signal and/or the first CW signal being received by the second group ambient IoT devices.

As shown by reference number 725, the ambient IoT device 710 may transmit a response to the reader 705. For example, the ambient IoT device 710 may transmit the response by backscattering of the first CW signal, in a manner similar to that described elsewhere herein.

In some aspects, the ambient IoT device 710 may transmit the response to the reader 705 based at least in part on the first wireless communication signal being transmitted at the first transmit power and/or based at least in part on the ambient IoT device 710 being located within the first range of distances.

In some aspects, the ambient IoT device 710 may transmit the response based at least in part on information included in the first wireless communication signal. In some aspects, the information included in the first wireless communication signal includes information associated with transmitting the response. For example, the first wireless communication signal may include scheduling information associated with transmitting the response to the first wireless communication signal, a resource allocation rate associated with transmitting the response to the first wireless communication signal, and/or an MCS associated with transmitting the response to the first wireless communication signal, among other examples. The ambient IoT device 710 may transmit the response based at least in part on the information associated with transmitting the response being included in the first wireless communication signal.

In some aspects, the information included in the first wireless communication signal may include information indicating a plurality of thresholds associated with the first group of ambient IoT devices (e.g., the ambient IoT device 710) determining whether to transmit a response to a wireless communication signal.

In some aspects, the plurality of thresholds may include a first threshold based on a received signal measurement and a second threshold based on the received signal measurement. For example, the plurality of thresholds may include first and/or second RSRP thresholds, first and/or second RSSI thresholds, and/or first and/or second RSRQ thresholds.

In some aspects, the ambient IoT device 710 may perform a measurement based at least in part on receiving the first wireless communication signal and/or the first CW signal. The ambient IoT device 710 may determine whether a measurement (e.g., a value of the measurement) satisfies the first threshold and/or the second threshold.

In some aspects, the ambient IoT device 710 may be configured to determine the measurement based at least in part on the type of device corresponding to the ambient IoT device 710. For example, the ambient IoT device 710 may be configured to perform the measurement based at least in part on the ambient IoT device 710 comprising a device 2a or 2b type ambient IoT device. As another example, the ambient IoT device 710 may not be configured to perform the measurement based at least in part on the ambient IoT device 710 comprising a device 1 type ambient IoT device.

In some aspects, the ambient IoT device 710 may transmit the response based at least in part on the measurement failing to satisfy (e.g., being less than) the second threshold. In some aspects, the ambient IoT device 710 may transmit the response based at least in part on the measurement failing to satisfy the second threshold without considering whether the measurement satisfies the first threshold.

In some aspects, the ambient IoT device 710 may transmit the response based at least in part on the measurement failing to satisfy the second threshold and the measurement satisfying (e.g., being greater than or equal to) the first threshold. In some aspects, the ambient IoT device 710 may transmit the response based at least in part on the measurement failing to satisfy (e.g., being less than) the first threshold.

In some aspects, the ambient IoT device 710 may transmit the response based at least in part on the measurement failing to satisfy both the first threshold and the second threshold. In some aspects, the ambient IoT device 710 may transmit the response based at least in part on the measurement failing to satisfy the first threshold without considering whether the measurement satisfies or fails to satisfy the second threshold.

In some aspects, the plurality of thresholds includes the first RSRP threshold and the second RSRP threshold. In some aspects, the ambient IoT device 710 may estimate the RSRP of the first wireless communication signal based on performing one or more measurements on the first wireless communication signal.

In some aspects, the ambient IoT device 710 may determine the RSRP of the first wireless communication signal based at least in part on an RSRP associated with the CW signal, the first transmit power, a reflection factor, and/or a pathloss associated the device-to-reader communication link via which the response to the first wireless communication signal is to be transmitted. For example, the ambient IoT device 710 may determine the RSRP associated with the wireless communication signal utilizing the following formula:

$$RSRP = {RSRP}_{C W 2 D} + {P}_{t x} - P {L}_{D 2 R} ,$$

where RSRP is the RSRP of the first wireless communication signal, RSRP_{CW2D} is the RSRP associated with the CW signal, Pₜₓ is the first transmit power or a reflection factor, and PL_{D2R} is the pathloss associated the device-to-reader communication link via which the response to the first wireless communication signal is to be transmitted.

In some aspects, the pathloss associated the device-to-reader communication link via which the response to the first wireless communication signal is to be transmitted may be dependent upon on a distance between the ambient IoT device 710 and the reader 705. In some aspects, the pathloss associated the device-to-reader communication link via which the response to the first wireless communication signal is to be transmitted may be measured based at least in part on the first wireless communication signal. For example, the pathloss associated the device-to-reader communication link via which the response to the first wireless communication signal is to be transmitted may be determined utilizing the following formulas:

$$R S R {P}_{R 2 D} = {P}_{tx \_ R 2 D} - P {L}_{R 2 D}$$

$$P {L}_{D 2 R} = P {L}_{R 2 D} = P {L}_{C W 2 D} = {P}_{tx \_ R 2 D} - P {L}_{R 2 D} .$$

In some aspects, the another device (e.g., another reader, a network node 110, or a UE 120, among other examples) is to receive the device-to-reader communication link, where the other device is separate from the first reader who transmits the reader-to-device communication link, i.e., PL_{D2R} is unequal to PL_{R2D}, and the other device coordinates with the first reader for the device-to-reader communication link reception. In some aspects, the ambient IoT device 710 may determine the pathloss associated the device-to-reader communication link via which the response to the first wireless communication signal is to be transmitted based at least in part on a signal transmitted by another device (e.g., another reader, a network node 110, or a UE 120, among other examples). In some aspects, the signal transmitted by the other device may comprise a reference signal and/or a signal transmitted by the other device to other ambient IoT devices.

In some aspects, the ambient IoT device 710 may estimate the pathloss associated the device-to-reader communication link via which the response to the first wireless communication signal is to be transmitted based at least in part on the reference signal and/or the signal transmitted by the other device to other ambient IoT devices. In some aspects, the reader 705 may transmit information to enable the ambient IoT device 710 to determine the pathloss associated with the device-to-reader communication link via which the response to the first wireless communication signal is to be transmitted based at least in part on the reference signal or the signal transmitted by the other device to the other ambient IoT devices. In some aspects, the ambient IoT device 710 may be preconfigured or configured by the first reader on when and/or how to measure the signal transmitted by the other device to estimate the pathloss PL_{D2R} of device-to-reader communication link.

In some aspects, the information may include information identifying the other device (e.g., a device identifier), a transmit power or reflection factor associated with the transmission of the reference signal and/or the signal transmitted by the other device to the other ambient IoT devices, and/or an indication of one or more resources that the ambient IoT device 710 is to measure, among other examples.

In some aspects, the ambient IoT device 710 may measure an RSRP associated with the reference signal and/or the signal transmitted by the other device to other ambient IoT devices. In some aspects, the ambient IoT device 710 may measure an RSRP associated with the reference signal and/or the signal transmitted by the other device to other ambient IoT devices in a manner similar to that described above with respect to determining the RSRP associated with the first wireless communication signal.

In some aspects, the ambient IoT device 710 may transmit the response based at least in part on the RSRP associated with the reference signal and/or the signal transmitted by the other device to other ambient IoT devices being less than or equal to the first RSRP threshold and greater than the second RSRP threshold.

In some aspects, the first wireless communication signal includes information indicating the first transmit power. In some aspects, the ambient IoT device 710 may determine to transmit the response based at least in part on the first transmit power satisfying one or more of the plurality of thresholds. For example, the ambient IoT device 710 may transmit the response based at least in part on the first transmit power satisfying (e.g., being less than or equal to) a transmit power threshold.

In some aspects, the first transmit power may comprise a (pre-) configured parameter. In some aspects, the ambient IoT device 710 may transmit the response based at least in part on the (pre-) configured parameter satisfying the transmit power threshold.

In some aspects, the first wireless communication signal may include information indicating a query index and/or another type of information that can be used to distinguish the first wireless communication signal from other wireless communication signals. In some aspects, the ambient IoT device 710 may transmit the response based at least in part on the query index and/or the other type of information. For example, the ambient IoT device 710 may determine that the query index comprises an index associated with the first group of ambient IoT devices, the ambient IoT device 710, and/or wireless communication signals to which the first group of ambient IoT devices and/or the ambient IoT device 710 are to transmit a response.

In some aspects, the ambient IoT device 715 may not transmit a response to the first wireless communication signal. In some aspects, the ambient IoT device 715 may not transmit a response to the first wireless communication signal based at least in part a location of the ambient IoT device 715 being included in the second range of distances R2 and/or based at least in part on the location of the ambient IoT device 715 not being included in the first range of distances R1.

In some aspects, the ambient IoT device 710 may transmit the response to another device that is different from the reader 705. For example, the ambient IoT device 710 may transmit the response to another reader device. In some aspects, transmitting the CW signal at the first transmit power may prevent the response from being received by the other device. For example, a distance between the ambient IoT device 710 and the other device may be greater than a distance between the ambient IoT device 710 and the reader 705 and the backscattering of the CW signal may not reach the other device based at least in part on the first transmit power being too low.

In some aspects, the reader 705 may perform power ramping to incrementally increase the transmit power of the CW signal. For example, the reader 705 may perform one or more re-transmissions of the CW signal and/or the first wireless communication signal.

In some aspects, the reader 705 may stop re-transmitting the CW signal and/or the first wireless communication signal based at least in part on the other device receiving the response. For example, the other device may transmit feedback indicating that the other device received the response to the reader 705. The reader 705 may stop re-transmitting the CW signal and/or the first wireless communication signal based at least in part on receiving the feedback from the other device.

In some aspects, as shown by reference number 730, the reader 705 may transmit feedback to the ambient IoT device 710. For example, the reader 705 may receive the response from the ambient IoT device 710. The reader 705 may transmit, to the ambient IoT device 710, feedback (e.g., an ACK or a NACK) indicating whether the response was successfully received by the reader 705. In some aspects, the response may be transmitted another device that is different from the reader 705 and the other device may transmit the feedback to the ambient IoT device 710.

In some aspects, the feedback may indicate that the reader 705 received the response. In some aspects, the ambient IoT device 710 may receive the feedback and may store information, set a flag, and/or perform another type of action indicating that the ambient IoT device 710 transmitted the response and/or that the response was received by the reader 705.

In some aspects, the feedback may comprise a re-transmission of the first wireless communication signal and/or the first CW signal. For example, the reader 705 may not receive the response from the ambient IoT device 710 and may re-transmit the first wireless communication signal and/or the first CW as feedback indicating that the response was not received by the reader 705.

In some aspects, the reader 705 may re-transmit the first wireless communication signal and/or the first CW at the first transmit power. Additionally, or alternatively, the reader 705 may re-transmit the first wireless communication signal and/or the first CW at a modified first transmit power. In some aspects, the modified first transmit power may be a higher power relative to the first transmit power.

In some aspects, the ambient IoT device 710 may re-transmit the response based at least in part on receiving the re-transmission of the first wireless communication signal and/or the first CW signal. In some aspects, the ambient IoT device 710 may retransmit the response in a manner similar to that described above with respect to reference number 725.

As shown by reference number 735, the reader 705 may transmit a second wireless communication signal and a second CW signal at a second transmit power. In some aspects, the second wireless communication signal may comprise a reader-to-device signal that is transmitted via a reader-to-device signal link between the reader 705 and the ambient IoT device 715.

In some aspects, the ambient IoT device 715 may be included in a second group of ambient IoT devices located within the second range of distances R2, and the second wireless communication signal and the second CW signal may be transmitted at the second transmit power to enable the second group of ambient IoT devices to receive the second wireless communication signal and to utilize the second CW signal to transmit a response to the second wireless communication signal.

In some aspects, the reader 705 may transmit the second wireless communication signal and/or the second CW signal based at least in part on performing a ramping of the transmit power. For example, the reader 705 may transmit the second wireless communication signal and/or the second CW signal at an initial transmit power and may gradually (e.g., in pre-configured increments) increase the transmit power to enable the second wireless communication signal and/or the second CW signal to be received by a second group of ambient IoT devices located within the second range of distances R2.

As shown by reference number 740, the ambient IoT device 715 may transmit a response to the reader 705. For example, the ambient IoT device 715 may transmit the response by backscattering of the second CW signal, in a manner similar to that described elsewhere herein. In some aspects, the ambient IoT device 715 may transmit the response to the reader 705 based at least in part on the second wireless communication signal being transmitted at the second transmit power and/or based at least in part on the ambient IoT device 715 being located within the second range of distances.

In some aspects, the ambient IoT device 715 may transmit the response based at least in part on information included in the second wireless communication signal. In some aspects, the information included in the second wireless communication signal includes information associated with transmitting the response. For example, the second wireless communication signal may include scheduling information associated with transmitting the response to the second wireless communication signal, a resource allocation rate associated with transmitting the response to the second wireless communication signal, and/or an MCS associated with transmitting the response to the second wireless communication signal, among other examples.

In some aspects, the information included in the second wireless communication signal may include information indicating a plurality of thresholds associated with the second group of ambient IoT devices (e.g., the ambient IoT device 715) determining whether to transmit a response to a wireless communication signal.

In some aspects, the plurality of thresholds may include a first threshold based on a received signal measurement and a second threshold based on the received signal measurement. For example, the plurality of thresholds may include first and/or second RSRP thresholds, first and/or second RSSI thresholds, and/or first and/or second RSRQ thresholds.

In some aspects, the ambient IoT device 715 may perform a measurement based at least in part on receiving the second wireless communication signal and/or the second CW signal. The ambient IoT device 715 may determine whether a value of the measurement satisfies the first threshold and/or the second threshold. The ambient IoT device 715 may transmit the response based at least in part on the value of the measurement satisfying the first threshold and/or the second threshold.

In some aspects, the second wireless communication signal includes information indicating the second transmit power. In some aspects, the ambient IoT device 715 may determine to transmit the response based at least in part on the second transmit power satisfying one or more of the plurality of thresholds. For example, the ambient IoT device 715 may transmit the response based at least in part on the second transmit power satisfying (e.g., being greater than) a transmit power threshold.

In some aspects, the second transmit power may comprise a (pre-) configured parameter. In these aspects, the ambient IoT device 715 may transmit the response based at least in part on the (pre-) configured parameter satisfying the transmit power threshold.

In some aspects, the second wireless communication signal may include information indicating a query index and/or another type of information that can be used to distinguish the second wireless communication signal from other wireless communication signals (e.g., the first wireless communication signal). In some aspects, the ambient IoT device 715 may transmit the response based at least in part on the query index and/or the other type of information. For example, the ambient IoT device 715 may determine that the query index comprises an index associated with the second group of ambient IoT devices, the ambient IoT device 715, and/or wireless communication signals to which the second group of ambient IoT devices and/or the ambient IoT device 715 are to transmit a response.

In some aspects, the ambient IoT device 710 may refrain from transmitting a response to the second wireless communication signal. In some aspects, the ambient IoT device 710 may refrain from transmitting a response to the second wireless communication signal based at least in part on determining that the ambient IoT device 710 transmitted a response to the first wireless communication signal. For example, the ambient IoT device 710 may store information, set a flag, and/or perform another type of action indicating that the ambient IoT device 710 transmitted the response to the first wireless communication signal and/or that the response to the first wireless communication signal was received by the reader 705.

In some aspects, the ambient IoT device 710 may determine that the ambient IoT device 710 transmitted a response to the first wireless communication signal based at least in part on the stored information, the set flag, and/or the performance of another type of action indicating that the ambient IoT device 710 transmitted the response to the first wireless communication signal and/or that the response to the first wireless communication signal was received by the reader 705. The ambient IoT device 710 may refrain from transmitting a response to the second wireless communication signal based at least in part on determining that the ambient IoT device 710 transmitted the response to the first wireless communication signal.

In some aspects, the ambient IoT device 710 may refrain from transmitting a response to the second wireless communication signal based at least in part on information included in the first wireless communication signal. In some aspects, the information included in the first wireless communication signal may include information indicating a plurality of thresholds associated with the first group of ambient IoT devices (e.g., the ambient IoT device 710) determining whether to transmit a response to a wireless communication signal.

In some aspects, the plurality of thresholds may include a first threshold based on a received signal measurement and a second threshold based on the received signal measurement. For example, the plurality of thresholds may include first and/or second RSRP thresholds, first and/or second RSSI thresholds, and/or first and/or second RSRQ thresholds.

In some aspects, the ambient IoT device 710 may perform a measurement based at least in part on receiving the second wireless communication signal and/or the second CW signal. The ambient IoT device 710 may determine whether a measurement (e.g., a value of the measurement) satisfies the first threshold and/or the second threshold. In some aspects, the ambient IoT device 710 may refrain from transmitting the response based at least in part on the measurement satisfying (e.g., greater than or equal to) the first threshold.

For example, the ambient IoT device 710 may transmit the response to the first wireless communication signal based at least in part on a measurement associated with the first wireless communication signal failing to satisfy (e.g., being less than) the first threshold. The ambient IoT device 710 may refrain from transmitting the response to the second wireless communication signal based at least in part on transmitting the response to the first wireless communication signal based at least in part on a measurement associated with the first wireless communication signal failing to satisfy the first threshold and based at least in part on the measurement associated with the second wireless communication signal satisfying (e.g., being greater than or equal to) the first threshold. Additionally, or alternatively, the ambient IoT device 710 may refrain from transmitting the response based at least in part on the measurement satisfying (e.g., being greater than or equal to) the second threshold.

In some aspects, the second wireless communication signal includes information indicating the second transmit power. In some aspects, the ambient IoT device 710 may refrain from transmitting the response based at least in part on the second transmit power satisfying one or more of the plurality of thresholds. For example, the ambient IoT device 710 may transmit the response based at least in part on the first transmit power satisfying (e.g., greater than) a transmit power threshold.

In some aspects, the second transmit power may comprise a (pre-) configured parameter. In some aspects, the ambient IoT device 710 may refrain from transmitting the response based at least in part on the (pre-) configured parameter satisfying the transmit power threshold.

In some aspects, the second wireless communication signal may include information indicating a query index and/or another type of information that can be used to distinguish the first wireless communication signal from other wireless communication signals (e.g., the first wireless communication signal). In some aspects, the ambient IoT device 710 may refrain from transmitting the response to the second wireless communication signal based at least in part on the query index and/or the other type of information included in the second wireless communication signal. For example, the ambient IoT device 710 may determine that the query index is different from a query index included in the first wireless communication signal, that the query index comprises an index associated with the second group of ambient IoT devices, the ambient IoT device 715, and/or wireless communication signals to which the first group of ambient IoT devices and/or the ambient IoT device 710 are to refrain from transmitting a response.

As indicated above, FIGS. 7A and 7B are provided as an example. Other examples may differ from what is described with respect to FIGS. 7A and 7B.

FIG. 8 is a diagram illustrating an example process 800 performed, for example, at a reader or an apparatus of a reader, in accordance with the present disclosure. Example process 800 is an example where the apparatus or the reader (e.g., reader 705) performs operations associated with ambient IoT device-to-reader transmission control.

As shown in FIG. 8, in some aspects, process 800 may include transmitting a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power (block 810). For example, the reader (e.g., using transmission component 1004 and/or communication manager 1006, depicted in FIG. 10) may transmit a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power, as described above.

As further shown in FIG. 8, in some aspects, process 800 may include transmitting a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power (block 820). For example, the reader (e.g., using transmission component 1004 and/or communication manager 1006, depicted in FIG. 10) may transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power, as described above.

Process 800 may include additional aspects, such as any single aspect or any combination of aspects described below and/or in connection with one or more other processes described elsewhere herein.

In a first aspect, the first group of ambient IoT devices refrain from transmitting a response to the second wireless communication signal based at least in part on the first group of ambient IoT devices transmitting a response to the first wireless communication signal, the first group of ambient IoT devices being located within the first range of distances from the reader, the second wireless communication signal being transmitted at the second transmit power, or a combination thereof.

In a second aspect, alone or in combination with the first aspect, the second wireless communication signal is transmitted at the second transmit power based at least in part on applying power ramping or de-ramping to modify the first transmit power.

In a third aspect, alone or in combination with one or more of the first and second aspects, one or more of the first wireless communication signal or the second wireless communication signal comprises a reader-to-device signal, a continuous wave signal, or a combination thereof.

In a fourth aspect, alone or in combination with one or more of the first through third aspects, the one or more of the first wireless communication signal or the second wireless communication signal includes the reader-to-device signal and the continuous wave signal, and wherein the continuous wave signal is transmitted by a device that is different from the reader.

In a fifth aspect, alone or in combination with one or more of the first through fourth aspects, process 800 includes receiving, by the reader, a signal indicating that the continuous wave signal is to be transmitted by the device that is different from the reader.

In a sixth aspect, alone or in combination with one or more of the first through fifth aspects, the signal indicating that the continuous wave signal is to be transmitted by the device that is different from the reader is received from a controller associated with the reader, the first group of ambient IoT devices, the second group of ambient IoT devices, the device that is different from the reader, or a combination thereof.

In a seventh aspect, alone or in combination with one or more of the first through sixth aspects, the device that is different from the reader comprises another reader or a continuous wave device configured to transmit a continuous wave to ambient IoT devices.

In an eighth aspect, alone or in combination with one or more of the first through seventh aspects, the response to the first wireless communication signal or the response to the second wireless communication signal comprises a device-to-reader signal that is transmitted to the reader or to another reader.

In a ninth aspect, alone or in combination with one or more of the first through eighth aspects, the first wireless communication signal indicates information associated with transmitting the response to the first wireless communication signal.

In a tenth aspect, alone or in combination with one or more of the first through ninth aspects, the information associated with transmitting the response to the first wireless communication signal comprises scheduling information associated with transmitting the response to the first wireless communication signal, a resource allocation rate associated with transmitting the response to the first wireless communication signal, a modulation and coding scheme associated with transmitting the response to the first wireless communication signal, or a combination thereof.

In an eleventh aspect, alone or in combination with one or more of the first through tenth aspects, the response to the first wireless communication signal is transmitted based at least in part on the scheduling information associated with transmitting the response to the first wireless communication signal, the resource allocation rate associated with transmitting the response to the first wireless communication signal, the modulation and coding scheme associated with transmitting the response to the first wireless communication signal, or the combination thereof.

In a twelfth aspect, alone or in combination with one or more of the first through eleventh aspects, the response to the first wireless communication signal is transmitted further based at least in part on a continuous wave signal transmitted to the first group of ambient IoT devices.

In a thirteenth aspect, alone or in combination with one or more of the first through twelfth aspects, the second wireless communication signal indicates information associated with transmitting the response to the second wireless communication signal.

In a fourteenth aspect, alone or in combination with one or more of the first through thirteenth aspects, the information associated with transmitting the response to the second wireless communication signal comprises scheduling information associated with transmitting the response to the second wireless communication signal, a resource allocation rate associated with transmitting the response to the second wireless communication signal, a modulation and coding scheme associated with transmitting the response to the second wireless communication signal, or a combination thereof.

In a fifteenth aspect, alone or in combination with one or more of the first through fourteenth aspects, the response to the second wireless communication signal is transmitted based at least in part on the scheduling information associated with transmitting the response to the second wireless communication signal, the resource allocation rate associated with transmitting the response to the second wireless communication signal, the modulation and coding scheme associated with transmitting the response to the second wireless communication signal, or the combination thereof.

In a sixteenth aspect, alone or in combination with one or more of the first through fifteenth aspects, the response to the second wireless communication signal is transmitted further based at least in part on a continuous wave signal transmitted to the second group of ambient IoT devices.

In a seventeenth aspect, alone or in combination with one or more of the first through sixteenth aspects, the first transmit power comprises a lower power relative to the second transmit power.

In an eighteenth aspect, alone or in combination with one or more of the first through seventeenth aspects, the first transmit power decreases a probability of the first wireless communication signal being received by the second group of ambient IoT devices.

In a nineteenth aspect, alone or in combination with one or more of the first through eighteenth aspects, the second wireless communication signal is transmitted at a second transmit power based at least in part on applying power ramping to modify the first transmit power, wherein the power ramping is applied to modify the first transmit power by increasing the first transmit power during a transmission of a group of second wireless communication signals, wherein the group of second wireless communication signals includes the second wireless communication signal, and wherein increasing the first transmit power during the transmission of the group of second wireless communication signals enables the group of second wireless communication signals to cover an area corresponding to the second range of distances.

In a twentieth aspect, alone or in combination with one or more of the first through nineteenth aspects, process 800 includes receiving, by the reader, the response to the first wireless communication signal transmitted by the first group of ambient IoT devices.

In a twenty-first aspect, alone or in combination with one or more of the first through twentieth aspects, process 800 includes transmitting, by the reader and to the first group of ambient IoT devices, feedback indicating that the response to the first wireless communication signal transmitted by the first group of ambient IoT devices was received by the reader.

In a twenty-second aspect, alone or in combination with one or more of the first through twenty-first aspects, the first wireless communication signal indicates a plurality of thresholds for determining whether the first group of ambient IoT devices are to transmit the response to the first wireless communication signal, the second wireless communication signal, or a combination thereof.

In a twenty-third aspect, alone or in combination with one or more of the first through twenty-second aspects, the plurality of thresholds includes a first threshold based on a received signal measurement and a second threshold based on the received signal measurement.

In a twenty-fourth aspect, alone or in combination with one or more of the first through twenty-third aspects, the plurality of thresholds includes a reference signal received power threshold, a received signal strength indicator threshold, a reference signal received quality threshold, or a combination thereof.

In a twenty-fifth aspect, alone or in combination with one or more of the first through twenty-fourth aspects, the first wireless communication signal indicates the first transmit power.

In a twenty-sixth aspect, alone or in combination with one or more of the first through twenty-fifth aspects, the first transmit power corresponds to a pre-configured parameter.

In a twenty-seventh aspect, alone or in combination with one or more of the first through twenty-sixth aspects, the first transmit power comprises a higher power relative to the second transmit power.

In a twenty-eighth aspect, alone or in combination with one or more of the first through twenty-seventh aspects, the second wireless communication signal is transmitted at the second transmit power based at least in part on applying power de-ramping to modify the first transmit power.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at an ambient IoT device or an apparatus of an ambient IoT device, in accordance with the present disclosure. Example process 900 is an example where the apparatus or the ambient IoT device (e.g., ambient IoT device 710, 715) performs operations associated with ambient IoT device-to-reader transmission control.

As shown in FIG. 9, in some aspects, process 900 may include receiving a first wireless communication signal (block 910). For example, the ambient IoT device (e.g., using reception component 1102 and/or communication manager 1106, depicted in FIG. 11) may receive a first wireless communication signal, as described above.

As further shown in FIG. 9, in some aspects, process 900 may include transmitting a response to the first wireless communication signal (block 920). For example, the ambient IoT device (e.g., using transmission component 1104 and/or communication manager 1106, depicted in FIG. 11) may transmit a response to the first wireless communication signal, as described above.

As further shown in FIG. 9, in some aspects, process 900 may include receiving a second wireless communication signal, wherein the ambient IoT refrains from transmitting a response to the second wireless communication signal based at least in part on transmitting the response to the first wireless communication signal (block 930). For example, the ambient IoT device (e.g., using reception component 1102 and/or communication manager 1106, depicted in FIG. 11) may receive a second wireless communication signal, wherein the ambient IoT refrains from transmitting a response to the second wireless communication signal based at least in part on transmitting the response to the first wireless communication signal, as described above.

Process 900 may include additional aspects, such as any single aspect or any combination of aspects described below and/or in connection with one or more other processes described elsewhere herein.

In a first aspect, the first wireless communication signal comprises a reader-to-device signal transmitted by a reader to the ambient IoT device, a continuous wave signal, or a combination thereof.

In a second aspect, alone or in combination with the first aspect, the first wireless communication signal includes the reader-to-device signal and the continuous wave signal, and wherein the continuous wave signal is transmitted by a device that is different from the reader.

In a third aspect, alone or in combination with one or more of the first and second aspects, the device that is different from the reader comprises another reader or a device configured to transmit the continuous wave signal.

In a fourth aspect, alone or in combination with one or more of the first through third aspects, process 900 includes receiving a communication indicating that the response to the first wireless communication signal was received by a reader, wherein the response to the second wireless communication signal is not transmitted based at least in part on the communication.

In a fifth aspect, alone or in combination with one or more of the first through fourth aspects, process 900 includes setting a flag based at least in part on receiving the communication, wherein the response to the second wireless communication signal is not transmitted based at least in part on the flag being set.

In a sixth aspect, alone or in combination with one or more of the first through fifth aspects, the response to the second wireless communication signal is not transmitted based at least in part on a transmit power associated with the second wireless communication signal.

In a seventh aspect, alone or in combination with one or more of the first through sixth aspects, the second wireless communication signal indicates a query index associated with the second wireless communication signal, and wherein the response to the second wireless communication signal is not transmitted based at least in part on the query index being different from a query index associated with the first wireless communication signal.

In an eighth aspect, alone or in combination with one or more of the first through seventh aspects, process 900 includes receiving an indication of a plurality of power thresholds, wherein the response to the first wireless communication signal is transmitted based at least in part on the plurality of power thresholds and a transmit power associated with the first wireless communication signal.

In a ninth aspect, alone or in combination with one or more of the first through eighth aspects, the plurality of power thresholds comprises a first RSRP threshold and a second RSRP threshold.

In a tenth aspect, alone or in combination with one or more of the first through ninth aspects, a first RSRP is determined based at least in part on the first wireless communication signal, and wherein the response is transmitted based at least in part on the first RSRP being less than or equal to the first RSRP threshold, and based at least in part on the RSRP being greater than the second RSRP threshold.

In an eleventh aspect, alone or in combination with one or more of the first through tenth aspects, the first wireless communication signal includes a reader-to-device signal and a continuous wave signal, and wherein the first RSRP is determined based at least in part on a second RSRP associated with the reader-to-device signal.

In a twelfth aspect, alone or in combination with one or more of the first through eleventh aspects, the second RSRP is determined based at least in part on a third RSRP associated with the continuous wave signal, a path loss associated with the first wireless communication signal, and one or more of the transmit power associated with the first wireless communication signal or a reflection factor associated with the continuous wave signal.

In a thirteenth aspect, alone or in combination with one or more of the first through twelfth aspects, the path loss associated with the first wireless communication signal is determined based at least in part on a distance between the ambient IoT device and a reader that transmits the first wireless communication signal.

In a fourteenth aspect, alone or in combination with one or more of the first through thirteenth aspects, the distance between the ambient IoT device and the reader that transmits the first wireless communication signal is determined based at least in part on the path loss associated with the reader-to-device signal and the transmit power associated with the first wireless communication signal, or on the reflection factor associated with the continuous wave signal.

In a fifteenth aspect, alone or in combination with one or more of the first through fourteenth aspects, the first wireless communication signal includes a reader-to-device signal transmitted by a first device and a continuous wave signal transmitted by a second device that is different from the first device, and wherein a distance between the ambient IoT device and the first device is greater than a distance between the ambient IoT device and the second device.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a reader, or a reader may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. In some aspects, the communication manager is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 or the processing system 145 described in connection with FIG. 1) of the reader.

In some aspects, the apparatus 1000 may be configured to perform one or more operations described herein in connection with FIGS. 3-7B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 and/or the network node 110 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE 120 and/or the network node 110 described above in connection with FIG. 1, such as a radio, one or more RF chains, one or more transceivers, or one or more modems, each of which may in turn be coupled with one or more antennas of the reader.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE 120 and/or the network node 110 described above in connection with FIG. 1, such as a radio, one or more RF chains, one or more transceivers, or one or more modems, each of which may in turn be coupled with one or more antennas of the reader described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power. The transmission component 1004 may transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

The reception component 1002 may receive a signal indicating that the continuous wave signal is to be transmitted by the device that is different from the reader.

The reception component 1002 may receive the response to the first wireless communication signal transmitted by the first group of ambient IoT devices.

The transmission component 1004 may transmit, to the first group of ambient IoT devices, feedback indicating that the response to the first wireless communication signal transmitted by the first group of ambient IoT devices was received by the reader.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be an ambient IoT device, or an ambient IoT device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 or the processing system 145 described in connection with FIG. 1) of the ambient IoT device.

In some aspects, the apparatus 1100 may be configured to perform one or more operations described herein in connection with FIGS. 3-7B. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE 120 described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE 120 described above in connection with FIG. 1, such as a radio, one or more RF chains, one or more transceivers, or one or more modems, each of which may in turn be coupled with one or more antennas of the ambient IoT device.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE 120 device described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a first wireless communication signal. The transmission component 1104 may transmit a response to the first wireless communication signal. The reception component 1102 may receive a second wireless communication signal, wherein the ambient IoT refrains from transmitting a response to the second wireless communication signal based at least in part on transmitting the response to the first wireless communication signal.

The reception component 1102 may receive a communication indicating that the response to the first wireless communication signal was received by a reader, wherein the response to the second wireless communication signal is not transmitted based at least in part on the communication.

The communication manager 1106 may set a flag based at least in part on receiving the communication, wherein the response to the second wireless communication signal is not transmitted based at least in part on the flag being set.

The reception component 1102 may receive an indication of a plurality of power thresholds, wherein the response to the first wireless communication signal is transmitted based at least in part on the plurality of power thresholds and a transmit power associated with the first wireless communication signal.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a reader, comprising: transmitting, by the reader, a first wireless communication signal to a first group of ambient IoT devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and transmitting, by the reader, a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

Aspect 2: The method of Aspect 1, wherein the first group of ambient IoT devices refrain from transmitting a response to the second wireless communication signal based at least in part on the first group of ambient IoT devices transmitting a response to the first wireless communication signal, the first group of ambient IoT devices being located within the first range of distances from the reader, the second wireless communication signal being transmitted at the second transmit power, or a combination thereof.

Aspect 3: The method of any of Aspects 1-2, wherein the second wireless communication signal is transmitted at the second transmit power based at least in part on applying power ramping or de-ramping to modify the first transmit power.

Aspect 4: The method of any of Aspects 1-3, wherein one or more of the first wireless communication signal or the second wireless communication signal comprises a reader-to-device signal, a continuous wave signal, or a combination thereof.

Aspect 5: The method of Aspect 4, wherein the one or more of the first wireless communication signal or the second wireless communication signal includes the reader-to-device signal and the continuous wave signal, and wherein the continuous wave signal is transmitted by a device that is different from the reader.

Aspect 6: The method of Aspect 5, further comprising: receiving, by the reader, a signal indicating that the continuous wave signal is to be transmitted by the device that is different from the reader.

Aspect 7: The method of Aspect 6, wherein the signal indicating that the continuous wave signal is to be transmitted by the device that is different from the reader is received from a controller associated with the reader, the first group of ambient IoT devices, the second group of ambient IoT devices, the device that is different from the reader, or a combination thereof.

Aspect 8: The method of Aspect 5, wherein the device that is different from the reader comprises another reader or a continuous wave device configured to transmit a continuous wave to ambient IoT devices.

Aspect 9: The method of any of Aspects 1-8, wherein the response to the first wireless communication signal or the response to the second wireless communication signal comprises a device-to-reader signal that is transmitted to the reader or to another reader.

Aspect 10: The method of any of Aspects 1-9, wherein the first wireless communication signal indicates information associated with transmitting the response to the first wireless communication signal.

Aspect 11: The method of Aspect 10, wherein the information associated with transmitting the response to the first wireless communication signal comprises scheduling information associated with transmitting the response to the first wireless communication signal, a resource allocation rate associated with transmitting the response to the first wireless communication signal, a modulation and coding scheme associated with transmitting the response to the first wireless communication signal, or a combination thereof.

Aspect 12: The method of Aspect 11, wherein the response to the first wireless communication signal is transmitted based at least in part on the scheduling information associated with transmitting the response to the first wireless communication signal, the resource allocation rate associated with transmitting the response to the first wireless communication signal, the modulation and coding scheme associated with transmitting the response to the first wireless communication signal, or the combination thereof.

Aspect 13: The method of Aspect 12, wherein the response to the first wireless communication signal is transmitted further based at least in part on a continuous wave signal transmitted to the first group of ambient IoT devices.

Aspect 14: The method of any of Aspects 1-13, wherein the second wireless communication signal indicates information associated with transmitting the response to the second wireless communication signal.

Aspect 15: The method of Aspect 14, wherein the information associated with transmitting the response to the second wireless communication signal comprises scheduling information associated with transmitting the response to the second wireless communication signal, a resource allocation rate associated with transmitting the response to the second wireless communication signal, a modulation and coding scheme associated with transmitting the response to the second wireless communication signal, or a combination thereof.

Aspect 16: The method of Aspect 15, wherein the response to the second wireless communication signal is transmitted based at least in part on the scheduling information associated with transmitting the response to the second wireless communication signal, the resource allocation rate associated with transmitting the response to the second wireless communication signal, the modulation and coding scheme associated with transmitting the response to the second wireless communication signal, or the combination thereof.

Aspect 17: The method of Aspect 16, wherein the response to the second wireless communication signal is transmitted further based at least in part on a continuous wave signal transmitted to the second group of ambient IoT devices.

Aspect 18: The method of any of Aspects 1-17, wherein the first transmit power comprises a lower power relative to the second transmit power.

Aspect 19: The method of Aspect 18, wherein the first transmit power decreases a probability of the first wireless communication signal being received by the second group of ambient IoT devices.

Aspect 20: The method of any of Aspects 1-19, wherein the second wireless communication signal is transmitted at a second transmit power based at least in part on applying power ramping to modify the first transmit power, wherein the power ramping is applied to modify the first transmit power by increasing the first transmit power during a transmission of a group of second wireless communication signals, wherein the group of second wireless communication signals includes the second wireless communication signal, and wherein increasing the first transmit power during the transmission of the group of second wireless communication signals enables the group of second wireless communication signals to cover an area corresponding to the second range of distances.

Aspect 21: The method of any of Aspects 1-20, further comprising: receiving, by the reader, the response to the first wireless communication signal transmitted by the first group of ambient IoT devices.

Aspect 22: The method of Aspect 21, further comprising: transmitting, by the reader and to the first group of ambient IoT devices, feedback indicating that the response to the first wireless communication signal transmitted by the first group of ambient IoT devices was received by the reader.

Aspect 23: The method of any of Aspects 1-22, wherein the first wireless communication signal indicates a plurality of thresholds for determining whether the first group of ambient IoT devices are to transmit the response to the first wireless communication signal, the second wireless communication signal, or a combination thereof.

Aspect 24: The method of Aspect 23, wherein the plurality of thresholds includes a first threshold based on a received signal measurement and a second threshold based on the received signal measurement.

Aspect 25: The method of Aspect 23, wherein the plurality of thresholds includes a reference signal received power threshold, a received signal strength indicator threshold, a reference signal received quality threshold, or a combination thereof.

Aspect 26: The method of any of Aspects 1-25, wherein the first wireless communication signal indicates the first transmit power.

Aspect 27: The method of any of Aspects 1-26, wherein the first transmit power corresponds to a pre-configured parameter.

Aspect 28: The method of any of Aspects 1-27, wherein the first transmit power comprises a higher power relative to the second transmit power.

Aspect 29: The method of Aspect 28, wherein the second wireless communication signal is transmitted at the second transmit power based at least in part on applying power de-ramping to modify the first transmit power.

Aspect 30: A method of wireless communication performed by an ambient internet of things (IoT) device, comprising: receiving, by the ambient IoT device, a first wireless communication signal; transmitting, by the ambient IoT device, a response to the first wireless communication signal; and receiving, by the ambient IoT device, a second wireless communication signal, wherein the ambient IoT refrains from transmitting a response to the second wireless communication signal based at least in part on transmitting the response to the first wireless communication signal.

Aspect 31: The method of Aspect 30, wherein the first wireless communication signal comprises a reader-to-device signal transmitted by a reader to the ambient IoT device, a continuous wave signal, or a combination thereof.

Aspect 32: The method of Aspect 31, wherein the first wireless communication signal includes the reader-to-device signal and the continuous wave signal, and wherein the continuous wave signal is transmitted by a device that is different from the reader.

Aspect 33: The method of Aspect 32, wherein the device that is different from the reader comprises another reader or a device configured to transmit the continuous wave signal.

Aspect 34: The method of any of Aspects 30-33, further comprising: receiving a communication indicating that the response to the first wireless communication signal was received by a reader, wherein the response to the second wireless communication signal is not transmitted based at least in part on the communication.

Aspect 35: The method of Aspect 34, further comprising: setting a flag based at least in part on receiving the communication, wherein the response to the second wireless communication signal is not transmitted based at least in part on the flag being set.

Aspect 36: The method of any of Aspects 30-35, wherein the response to the second wireless communication signal is not transmitted based at least in part on a transmit power associated with the second wireless communication signal.

Aspect 37: The method of any of Aspects 30-36, wherein the second wireless communication signal indicates a query index associated with the second wireless communication signal, and wherein the response to the second wireless communication signal is not transmitted based at least in part on the query index being different from a query index associated with the first wireless communication signal.

Aspect 38: The method of any of Aspects 30-37, further comprising: receiving an indication of a plurality of power thresholds, wherein the response to the first wireless communication signal is transmitted based at least in part on the plurality of power thresholds and a transmit power associated with the first wireless communication signal.

Aspect 39: The method of Aspect 38, wherein the plurality of power thresholds comprises a first RSRP threshold and a second RSRP threshold.

Aspect 40: The method of Aspect 39, wherein a first RSRP is determined based at least in part on the first wireless communication signal, and wherein the response is transmitted based at least in part on the first RSRP being less than or equal to the first RSRP threshold, and based at least in part on the RSRP being greater than the second RSRP threshold.

Aspect 41: The method of Aspect 40, wherein the first wireless communication signal includes a reader-to-device signal and a continuous wave signal, and wherein the first RSRP is determined based at least in part on a second RSRP associated with the reader-to-device signal.

Aspect 42: The method of Aspect 41, wherein the second RSRP is determined based at least in part on a third RSRP associated with the continuous wave signal, a path loss associated with the first wireless communication signal, and one or more of the transmit power associated with the first wireless communication signal or a reflection factor associated with the continuous wave signal.

Aspect 43: The method of Aspect 42, wherein the path loss associated with the first wireless communication signal is determined based at least in part on a distance between the ambient IoT device and a reader that transmits the first wireless communication signal.

Aspect 44: The method of Aspect 43, wherein the distance between the ambient IoT device and the reader that transmits the first wireless communication signal is determined based at least in part on the path loss associated with the reader-to-device signal and the transmit power associated with the first wireless communication signal, or on the reflection factor associated with the continuous wave signal.

Aspect 45: The method of any of Aspects 30-44, wherein the first wireless communication signal includes a reader-to-device signal transmitted by a first device and a continuous wave signal transmitted by a second device that is different from the first device, and wherein a distance between the ambient IoT device and the first device is greater than a distance between the ambient IoT device and the second device.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.

Aspect 47: An apparatus for wireless communication at a device, the apparatus comprising one or more memories and one or more processors coupled to the one or more memories, the one or more processors configured to cause the device to perform the method of one or more of Aspects 1-45.

Aspect 48: An apparatus for wireless communication, the apparatus comprising at least one means for performing the method of one or more of Aspects 1-45.

Aspect 49: A non-transitory computer-readable medium storing code for wireless communication, the code comprising instructions executable by one or more processors to perform the method of one or more of Aspects 1-45.

Aspect 50: A non-transitory computer-readable medium storing a set of instructions for wireless communication, the set of instructions comprising one or more instructions that, when executed by one or more processors of a device, cause the device to perform the method of one or more of Aspects 1-45.

Aspect 51: A device for wireless communication, the device comprising a processing system that includes one or more processors and one or more memories coupled with the one or more processors, the processing system configured to cause the device to perform the method of one or more of Aspects 1-45.

Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify(for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a reader, comprising:
one or memories; and
one or more processors, the one or more processors, individually or collectively and based at least in part on information stored in the one or more memories, being configured to:
transmit a first wireless communication signal to a first group of ambient internet of things(IoT) devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and
transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

2. The apparatus of claim 1, wherein the first group of ambient IoT devices refrain from transmitting a response to the second wireless communication signal based at least in part on the first group of ambient IoT devices transmitting a response to the first wireless communication signal, the first group of ambient IoT devices being located within the first range of distances from the reader, the second wireless communication signal being transmitted at the second transmit power, or a combination thereof.

3. The apparatus of claim 1, wherein the second wireless communication signal is transmitted at the second transmit power based at least in part on applying power ramping or de-ramping to modify the first transmit power.

4. The apparatus of claim 1, wherein one or more of the first wireless communication signal or the second wireless communication signal comprises a reader-to-device signal, a continuous wave signal, or a combination thereof.

5. The apparatus of claim 1, wherein the response to the first wireless communication signal or the response to the second wireless communication signal comprises a device-to-reader signal that is transmitted to the reader or to another reader.

6. The apparatus of claim 1, wherein the first wireless communication signal indicates information associated with transmitting the response to the first wireless communication signal.

7. The apparatus of claim 6, wherein the information associated with transmitting the response to the first wireless communication signal comprises scheduling information associated with transmitting the response to the first wireless communication signal, a resource allocation rate associated with transmitting the response to the first wireless communication signal, a modulation and coding scheme associated with transmitting the response to the first wireless communication signal, or a combination thereof.

8. The apparatus of claim 7, wherein the response to the first wireless communication signal is transmitted based at least in part on the scheduling information associated with transmitting the response to the first wireless communication signal, the resource allocation rate associated with transmitting the response to the first wireless communication signal, the modulation and coding scheme associated with transmitting the response to the first wireless communication signal, or the combination thereof.

9. The apparatus of claim 8, wherein the response to the first wireless communication signal is transmitted further based at least in part on a continuous wave signal transmitted to the first group of ambient IoT devices.

10. The apparatus of claim 1, wherein the second wireless communication signal indicates information associated with transmitting the response to the second wireless communication signal.

11. The apparatus of claim 10, wherein the information associated with transmitting the response to the second wireless communication signal comprises scheduling information associated with transmitting the response to the second wireless communication signal, a resource allocation rate associated with transmitting the response to the second wireless communication signal, a modulation and coding scheme associated with transmitting the response to the second wireless communication signal, or a combination thereof.

12. The apparatus of claim 11, wherein the response to the second wireless communication signal is transmitted based at least in part on the scheduling information associated with transmitting the response to the second wireless communication signal, the resource allocation rate associated with transmitting the response to the second wireless communication signal, the modulation and coding scheme associated with transmitting the response to the second wireless communication signal, or the combination thereof.

13. The apparatus of claim 12, wherein the response to the second wireless communication signal is transmitted further based at least in part on a continuous wave signal transmitted to the second group of ambient IoT devices.

14. The apparatus of claim 1, wherein the first transmit power comprises a lower transmit power relative to the second transmit power.

15. The apparatus of claim 1, wherein the first transmit power comprises a higher transmit power relative to the second transmit power.

16. The apparatus of claim 1, wherein the one or more processors are further configured to:
transmit, to the first group of ambient IoT devices, feedback indicating whether the response to the first wireless communication signal transmitted by the first group of ambient IoT devices was successfully received by the reader.

17. The apparatus of claim 1, wherein the first wireless communication signal indicates the first transmit power.

18. The apparatus of claim 1, wherein the first wireless communication signal indicates a plurality of thresholds for determining whether the first group of ambient IoT devices are to transmit the response to the first wireless communication signal, the second wireless communication signal, or a combination thereof.

19. A method for wireless communication performed by a reader, comprising:
transmitting, by the reader, a first wireless communication signal to a first group of ambient internet of things(IoT) devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and
transmitting, by the reader, a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.

20. A non-transitory computer-readable medium storing a set of instructions for wireless communication, the set of instructions comprising:
one or more instructions that, when executed by one or more processors of a reader, cause the reader to:
transmit a first wireless communication signal to a first group of ambient internet of things(IoT) devices, wherein the first group of ambient IoT devices transmit a response to the first wireless communication signal based at least in part on the first group of ambient IoT devices being located within a first range of distances from the reader and based at least in part on the first wireless communication signal being transmitted at a first transmit power; and
transmit a second wireless communication signal to a second group of ambient IoT devices, wherein the second group of ambient IoT devices transmit a response to the second wireless communication signal based at least in part on the second group of ambient IoT devices being located within a second range of distances from the reader and based at least in part on the second wireless communication signal being transmitted at a second transmit power that is different from the first transmit power.
